(19) United States
(12) Patent Application Publication
(10) Pub. No.: US 2013/0159361 A1
(43) Pub. Date: Jun. 20, 2013

(54) ACCESS TO A FILE SYSTEM WITH SEMANTIC INDEXING

(71) Applicants: Maria Coralia Laura Maag, Nozay (FR); Hakim Hacid, Nozay (FR)

(72) Inventors: Maria Coralia Laura Maag, Nozay (FR); Hakim Hacid, Nozay (FR)

(73) Assignee: ALCATEL LUCENT, Paris (FR)

(21) Appl. No.: 13/805,440

(22) PCT Filed: May 2, 2011
(86) PCT No.: PCT/FR11/50997

§ 371 Date: Mar. 6, 2013

(30) Foreign Application Priority Data
Jun. 30, 2010 (FR) 1002766

(51) Int. Cl. G06F 17/30

(52) U.S. Cl. CPC G06F 17/3007
USPC 707/822

(57) ABSTRACT

A method for enabling the user of an application running on an information processing system to access a set of files organized into a directory tree, by means of an element of a human-machine interface comprising means of browsing within said tree from an initial position to a final position, wherein said initial position is determined based on a correlation between first semantic information provided by the application and second semantic information associated with the directories.

The present invention pertains to information processing systems that have a human-machine interface enabling a user to interact with applications that run on such a system.

These information processing systems may be desktop or laptop microcomputers, communication terminals, personal digital assistants (or PDAs), or any other equipment with a human-machine interface that makes it possible to manipulate files.

The system may locally possess a file system that can be saved on a hard drive or in a volatile memory. The file system may also be accessible via a communication network, whether local or not.

These files are conventionally organized into a directory tree. Each file is located at a position within the tree. Each directory may therefore comprise files and directories.

The information processing system has an operating software layer that makes it possible to implement applications and that provides those applications with different basic services including a human-machine interface, one element of which enables access to the file system. This human-machine interface is generally graphical, and the element in question generally comes in the form of a graphics window that comprises different means to browse within the directory tree.

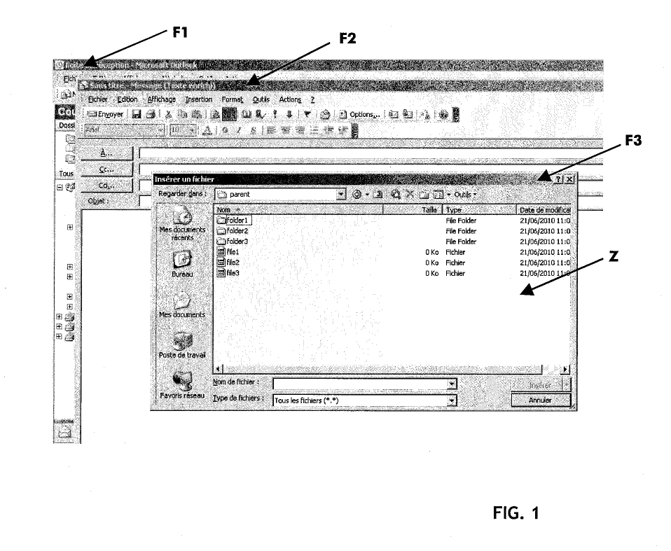

FIG. 1 depicts such a human-machine interface. Windows F1 and F2 correspond to an application. Whenever that application's user wants to access the file system a new window F3 appears. It presents various means (buttons, dropdown lists, etc.) allows browsing within the directory tree, a view of the current position of which is depicted in zone Z. This zone Z may show both files “file1”, “file2”,“file3” and directories “folder1”, “folder2”, “folder3”,

When the window F3 is displayed, the zone Z shows the view of the initial position, and the user can browse to a final position, for example in order to select a file or to save an open document in the application.

However, the initial position is generally the last position opened by the application or by the operating software layer. Sometimes, it may also be a position determined by the application by settings.

The user must therefore almost always browse to the desired position.

Whenever he or she must regularly manipulate files, this constant browsing becomes a waste of time and a source of a degradation in the human-machine interface's ergonomics.

The purpose of the invention is to enable the user to save time and to improve the ergonomics of file access.

To do so, a first object of the invention is a method for enabling the user of an application running on an information processing system to access a set of files organized into a directory tree, by means of an element of a human-machine interface comprising means of browsing within said tree from an initial position to a final position, wherein said initial position is determined based on a correlation between first semantic information provided by the application and second semantic information associated with the directories.

Thus, the inventive method makes it possible to offer the user an initial position of the means of browsing that is better than the one proposed in the state of the art, by correlating semantic information provided by the application that is used and by the file tree.

According to one implementation of the invention, the initial position maximizes said correlation.

The second semantic information may be determined in a prior step of analyzing the directory tree. This prior step may be triggered periodically or by a change within the tree.

The second information may associate keywords and weights, and potentially also file types.

A further object of the invention is a method for saving an open document within said application consisting of using the previously described method, choosing a file name, and saving said open document in the final position determined by the method in question.

The first semantic information may be determined by analyzing the contents of the document.

Another object of the invention is a method for inserting a file attached within an e-mail consisting of using the previously described method and of choosing a file from among those present in the final position thereby determined.

The first semantic information may be by analyzing the contents of said e-mail.

Further objects of the invention are an information processing device implementing one of those methods, a human-machine interface that has means adapted to implement them, and a software application comprising means of, when implemented on an information processing device, carrying out one of those methods.

The invention, its benefits, and its characteristics will become more clearly apparent in the following description, with reference to the attached figures.

FIG. 1, already commented upon, presents a human-machine interface according to the state of the art.

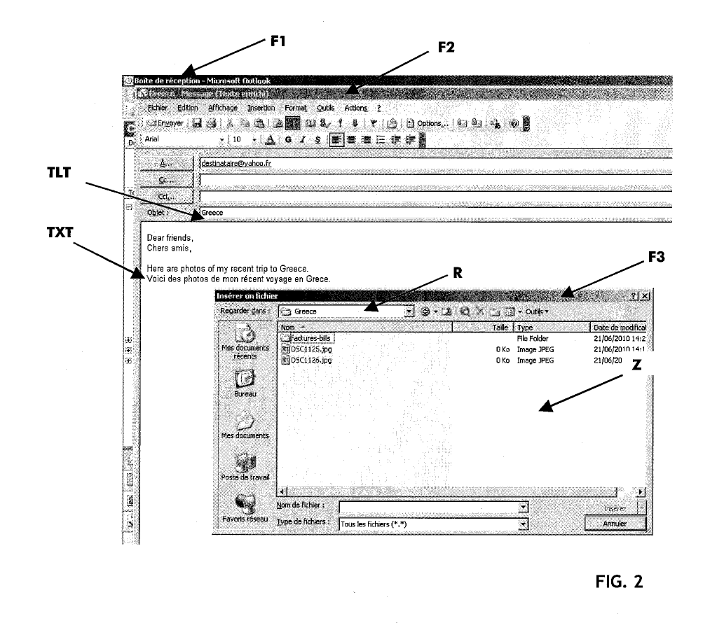

FIG. 2 depicts a human-machine interface implementing the invention.

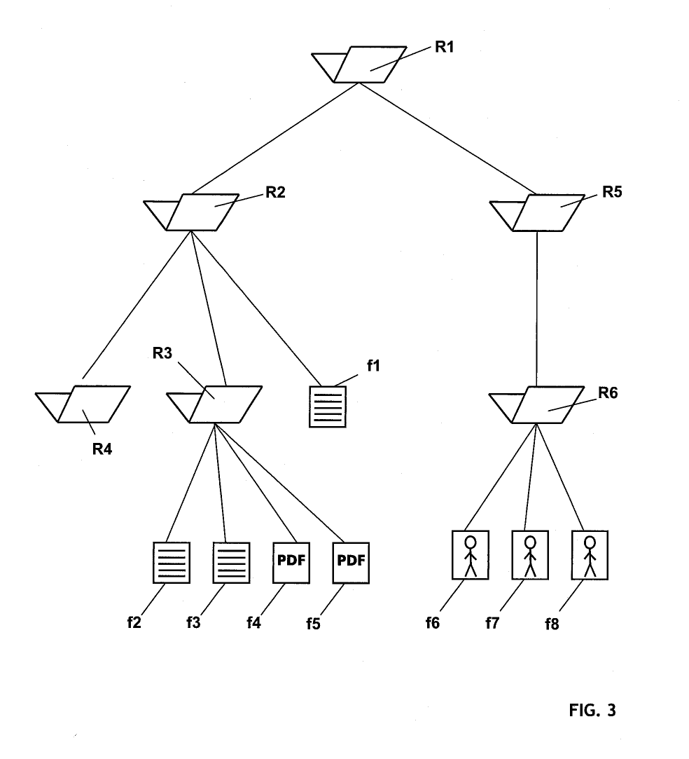

FIG. 3 diagrams an example directory tree, comprising files of different types.

The invention may apply to any sort of software application running on an information processing system.

FIG. 2 depicts one implementation with a tool for managing e-mails. It may particularly be a tool such as the software product “Outlook” sold by the company Microsoft.

The window F1 is the application's main window; the window F2 is the one that allows writing an e-mail. It comprises a menu and toolbars that enable access to the application's functions, as well as a zone that allows the input of the e-mail's main parameters (Recipient, Sender, title TLT, etc.), and a text zone TXT containing the e-mail's body.

Such a tool may allow the insertion of a file attached to an e-mail. A new window F3 opens up to allow access to the files. These files are organized into a directory tree. The field R shows the current directory, and the zone Z shows the contents of that directory. In this case, this content is comprised of two files “DSC1125.jpg” and “DSC1126.jpg” which are two photographs in JPEG format, and a “bills” directory.

The current directory is a position within the directory tree. In this example, the tree may be of the form:
Root
   Travel
      France
      Italy
      Greece
         Bills

According to the invention, semantic information is associated with at least some directories.

This semantic information may be determined in a prior step of analyzing the tree. This prior step may be triggered
periodically or
when a change is made within the tree (creating a new file, moving a file, or a directory, etc.).

But other possibilities are obviously possible.

The semantic information associated with a given directory may be determined based on the contents of that directory.

According to one embodiment, the content of the directories contained within that given directory are not taken into account in order to determine semantic information. FIG. 3 depicts a tree directory and a possible method for determining that semantic information.

The symbols R1, R2, R3, R4, R5, R6 represent directories. The symbols f1, f2, f3, f4, f5, f6, f7, f8 represent files of different types. The files f1, f2, f3 represent word-processing files (for example, from the application Word made by the company Microsoft); the files f4, f5 are files in PDF format such as those produced by the application Acrobat made by the company Adobe; the files f6, f7, f8 are image files, for example photos, in JPEG format (for “Joint Photography Expert Group”).

The semantic information of the directory R1 is determined by analyzing files contained in that directory. As it contains none, no semantic information is associated with the directory R1.

The semantic information of the directory R2 is determined by the file f1.

The semantic information of the directory R3 is determined from analysis of the files f2, f3, f4 and f5.

No semantic information is associated with the directory R4 because that directory is empty.

No semantic information is associated with the directory R5 because that directory contains no file, only a directory R6.

The semantic information of the directory R6 is determined by analyzing files f6, f7 and f8.

According to one embodiment, this semantic information associates keywords and weights.
contents of texts
tags of image files
etc.

The weights may particularly be determined by the number of occurrences of a word. The more present a word is, the greater its weight may be. Additionally, the word's position may influence its weight: For example, an occurrence in the file's name may have more impact on the weight than an occurrence within the file.

The semantic information may also associate file types. The file types may, depending on the operating systems, be correlated with the extension of the file name. They include image files (“.jpg”, “.gif”, “.png” . . . ), text files (“.doc”, “.docx” . . . ), spreadsheet files (“.xls”) etc.

This semantic information may be stored in different ways. It is possible to have a database that collects the semantic information associated with each position within the file tree. It is also possible to store within each position a small file that collects the semantic information for it.

Whenever the application wants to access the file system, it also provides semantic information. This semantic information may result from an analysis of the context at the time of access.

In the example in FIG. 2, this semantic information may be determined by analyzing the fields TLT and TXT of the window F2.

These fields contain the words “Greece” in English and “Grèce” in French.

The inventive method correlates this semantic information with those associated with the tree directories. Preferentially, it is sought to maximize the correlation in order to provide the best result. It may, however, be provided to perform a not perfectly optimal correlation in order to take other constraints into account (using the last directory opened if it is very frequently accessed; minimizing access time, etc.)

Automatically, the “Greece” position in the directory tree is determined as maximizing the correlation between the two semantic information source.

This directory “Greece” contains a subdirectory “bills” that contains .xls or .doc files. The semantic information provided by the application also contains the keyword “photos” which results in a better correlation with the directory “Greece”, which contains “.jpg” files, than with its subdirectory, and therefore the “Greece” position in the tree is the one displayed in the browsing window F3.

1. A method for enabling the user of an application running on an information processing system to access a set of files organized into a directory tree, by means of an element of a human-machine interface comprising means of browsing within said tree from an initial position to a final position, wherein said initial position is determined based on a correlation between first semantic information provided by said application and second semantic information associated with said directories.

2. A method according to claim 1, wherein said initial position maximizes said correlation.

3. A method according to claim 1, wherein said second information is determined in a prior step of analyzing said tree.

4. A method according to claim 1, wherein said prior step is triggered periodically.

5. A method according to claim 3 wherein said prior step is triggered by a change within said tree.

6. A method according to claim 1, wherein said second information associates keywords and weights.

7. A method according to claim 1, wherein said second information associates keywords, weights, and file types.

8. A method of saving an open document within said application consisting of using the method according to claim 1, choosing a file name, and saving said open document in said final position.

9. A method of saving according to claim 1, wherein said first semantic information is determined by analyzing the content of said document.

10. A method of inserting a file attached to an e-mail consisting of using the method according to claim 1 and of choosing a file from among those present in said final position.

11. A method of inserting according to claim 1, wherein said first semantic information is determined by analyzing the content of said e-mail.

12. An information processing device implementing a method according to claim 1.

13. A human-machine interface that has means adapted to implement a method according to claim 1.

14. A software application comprising means of, whenever implemented on an information processing device, executing the method according to claim 1.
